(19) United States
(12) Patent Application Publication
(10) Pub. No.: US 2025/0163942 A1
(43) Pub. Date: May 22, 2025

(54) HYDRAULICALLY AMPLIFIED SELF-HEALING ELECTROSTATIC ACTUATOR

(71) Applicant: Electronics and Telecommunications Research Institute, Daejeon (KR)

(72) Inventors: Han Vit KIM, Daejeon (KR); Hyung Ju PARK, Suwon-si (KR); Jeong Won PARK, Seoul (KR)

(21) Appl. No.: 18/952,545

(22) Filed: Nov. 19, 2024

(30) Foreign Application Priority Data
Nov. 20, 2023 (KR) 10-2023-0160963

(51) Int. Cl. F15B 21/06; F15B 5/00; F15B 15/10; F15B 15/20

(52) U.S. Cl. CPC F15B 21/06; F15B 5/006; F15B 15/103; F15B 15/20; F15B 2015/208

(57) ABSTRACT

A hydraulically amplified self-healing electrostatic (HASEL) actuator based on carbon-coated nanoparticles are disclosed. According to an embodiment of a present disclosure, the HASEL actuator includes a dielectric fluid, which is a liquid-type insulator that has polarity when voltage is applied, a film configured to covering the dielectric fluid and electrodes attached to both outer surfaces of the film and configured to move the dielectric fluid. And the dielectric fluid includes nanoparticles including ferroelectrics.

### CROSS-REFERENCE TO RELATED APPLICATIONS

The present application is based on, and claims priority from, Korean Patent Application Number 10-2023-0160963, filed Nov. 20, 2023, the disclosure of which is incorporated by reference herein in its entirety.

### TECHNICAL FIELD

The present disclosure relates to a hydraulically amplified self-healing electrostatic (HASEL) actuator. More specifically, the present disclosure relates to a hydraulically amplified self-healing electrostatic) actuator including a dielectric fluid mixed with carbon-coated nanoparticles.

### BACKGROUND

The content described below merely provides background information related to the present embodiment and does not constitute prior art.

Soft robotics is a rapidly emerging field that is widely used in a medical industry, a robot industry, or the like. A rigid body robot, which has been the core of the robot industry, has a rigid joint structure, making it difficult to perform delicate tasks. The soft robotics can perform delicate tasks using flexible materials, and has the advantages of low cost and multifunctionality. Accordingly, various biomimetic soft robots are being studied, and among them, a hydraulically amplified self-healing electrostatic (HASEL) actuator is being studied in detail. The HASEL actuator is an artificial muscle that combines Maxwell stress and hydraulic power to recognize its own deformation state and self-heal from electrical damage.

Contraction performance and actuation performance of the HASEL actuator vary not only by the shape, size, or design of the actuator, but also by the components included in the actuator. Accordingly, a method to improve the contraction performance and actuation performance of the HASEL actuator is required.

### SUMMARY

The present disclosure aims to include nanoparticles including ferroelectrics in a dielectric fluid of a hydraulically amplified self-healing electrostatic (HASEL) actuator.

In addition, according to one embodiment, the present disclosure aims to include carbon-coated nanoparticles in the dielectric fluid of the HASEL actuator.

The problems to be solved by the present disclosure are not limited to the problems mentioned above, and other problems not mentioned can be clearly understood by those skilled in the art from the description below.

According to the present disclosure, a hydraulically amplified self-healing electrostatic (HASEL) actuator includes a dielectric fluid, which is a liquid-type insulator that has polarity when voltage is applied, a film configured to covering the dielectric fluid and electrodes attached to both outer surfaces of the film and configured to move the dielectric fluid. And the dielectric fluid includes nanoparticles including ferroelectrics.

According to the present disclosure, by including nanoparticles containing ferroelectrics in the dielectric fluid of the HASEL actuator, the dielectric constant of the dielectric fluid can be increased and contraction efficiency of the HASEL actuator can be improved.

In addition, according to one embodiment, by coating carbon on nanoparticles included in the dielectric fluid of the HASEL actuator, the nanoparticles can be well dispersed in the dielectric fluid and the contraction efficiency of the HASEL actuator can be improved.

The effects that can be obtained from the present disclosure are not limited to the effects mentioned above, and other effects that are not mentioned can be clearly understood by those skilled in the art to which the present disclosure belongs from the description below.

### BRIEF DESCRIPTION OF THE DRAWINGS

FIG. 1 is a front view illustrating a hydraulically amplified self-healing electrostatic (HASEL) actuator according to one embodiment of the present disclosure.

FIG. 2A and FIG. 2B are side views illustrating the HASEL actuator according to one embodiment of the present disclosure.

FIG. 3A and FIG. 3B are front views illustrating before and after the HASEL actuator is actuated according to one embodiment of the present disclosure.

FIG. 4 is a view illustrating a dielectric fluid of the HASEL actuator according to one embodiment of the present disclosure.

FIG. 5 is a view illustrating an average external force of the HASEL actuator by voltage application according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

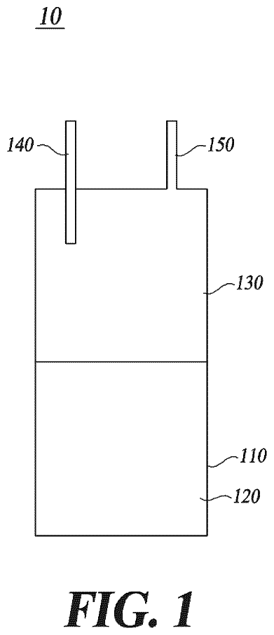

FIG. 1 is a front view illustrating a hydraulically amplified self-healing electrostatic (HASEL) actuator according to one embodiment of the present disclosure.

Referring to FIG. 1, a HASEL actuator 10 may have an approximately rectangular shape. The HASEL actuator 10 includes a film 110, a dielectric fluid 120, an electrode 130, a (+) wire 140, a (−) wire 150, or the like. The HASEL actuator 10 may have a shape other than a rectangular shape.

The film 110 may be a biaxially oriented polypropylene (BOPP) film. The BOPP film is a film manufactured by biaxially stretching polypropylene in a vertical direction. A portion between the films 110 is filled with the dielectric fluid 120. The inside of the fill 110 may be filled with the dielectric fluid 120 corresponding to half of a volume that can fill the inside of the film 110. The inside of the film 110 is filled with the dielectric fluid 120 using a micro pipette. The dielectric fluid 120 is a liquid-type insulator that has polarity in an electric field. The dielectric fluid 120 may be insulating oil.

The electrodes 130 are attached to both surfaces of the outside of the film 110. The electrodes 130 may be conductive electrodes. The electrodes 130 may be attached to the film 110 using a conductive double-sided carbon tape. The size of the electrode 130 may correspond to half the size of the HASEL actuator 10. The electrode 130 is connected to the (+) wire 140 and the (−) wire 150 to supply power.

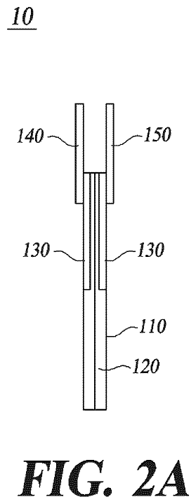

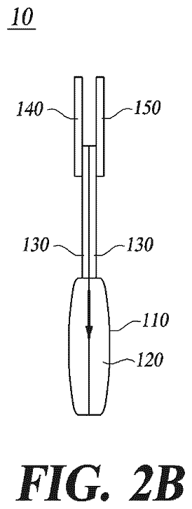

FIG. 2A and FIG. 2B are side views illustrating the HASEL actuator according to one embodiment of the present disclosure.

Referring to FIG. 2A, before the HASEL actuator 10 is actuated, power is not supplied to the (+) wire 140 and the (−) wire 150. Since power is not supplied, voltage is not applied to the electrode 130. Accordingly, the electrode 130 does not contract. Since the electrode 130 does not contract, the dielectric fluid 120 between the electrodes 130 does not move downward. Since the dielectric fluid 120 does not move downward, the film 110 does not expand.

Referring to FIG. 2B, when the HASEL actuator 10 is actuated, power is supplied to the (+) wire 140 and the (−) wire 150, and voltage is applied to the electrode 130. When voltage is applied to the electrode 130, the electrode 130 contracts due to an electrostatic force. The dielectric fluid 120 between the electrodes 130 moves to a non-contracting portion. That is, the dielectric fluid 120 moves downward, which is the opposite region. The shape of the film 110 expands due to the hydraulic pressure generated as the dielectric fluid 120 moves downward.

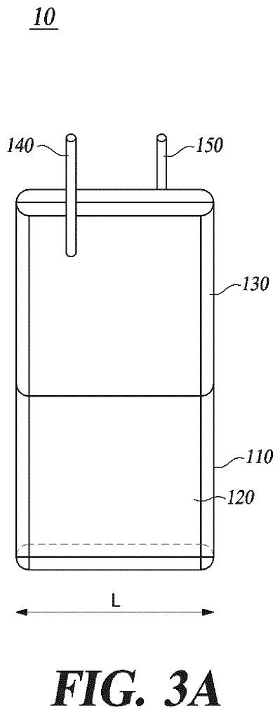

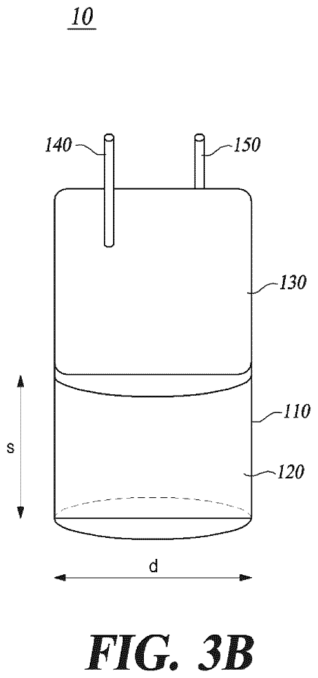

FIG. 3A and FIG. 3B are front views illustrating before and after the HASEL actuator is actuated according to one embodiment of the present disclosure.

Referring to FIG. 3A, before the HASEL actuator 10 is actuated, power is not supplied to the (+) wire 140 and the (−) wire 150. Since power is not supplied, voltage is not applied to the electrode 130, and the electrode 130 does not contract. Here, a horizontal length of the film 110 filled with dielectric fluid 120 may be L.

Referring to FIG. 3B, when the HASEL actuator 10 is actuated, power is supplied to the (+) wire 140 and the (−) wire 150, voltage is applied to the electrode 130, and the electrode 130 contracts. When the electrode 130 contracts and the film 110 expands to the maximum, the shape of the film 110 may correspond to an approximately cylindrical shape. Here, a length of a portion of a vertical length of the HASEL actuator 10 excluding a length where the electrode 130 is attached after the film 110 is expanded to the maximum may be s. s may be the vertical length of the film 110 and may be a vertical length corresponding to half of the total vertical length of the HASEL actuator 10. When the film 110 is expanded to the maximum, a diameter of a cylinder may correspond to d. Here, d which is the diameter of the cylinder may be expressed as in Mathematical Expression 1.

$$d = \frac{2 L}{π} \qquad [ Mathematical Expression 1 ]$$

An amount (Vc) of the dielectric fluid 120 injected into the film 110 may be an amount corresponding to half of the volume when the film 110 is expanded to the maximum. In this case, the amount of dielectric fluid 120 may be expressed as in Mathematical Expression 2.

$$Vc = \frac{π {d}^{2}}{4} \times s \qquad [ Mathematical Formula 2 ]$$

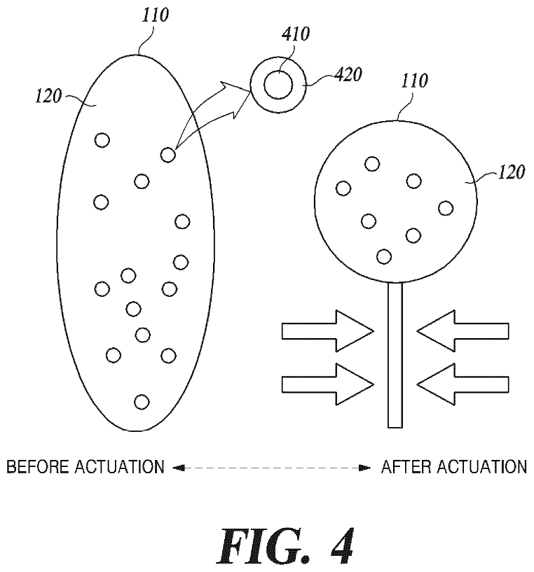

FIG. 4 is a view illustrating the dielectric fluid of the HASEL actuator according to one embodiment of the present disclosure.

Referring to FIG. 4, a contraction force of the HASEL actuator 10 may be changed by a constituent material. The contraction force of the HASEL actuator 10 is proportional to the size of the electric field applied by the applied voltage. When the size of the electric field is the same, the contraction efficiency of the HASEL actuator 10 is determined by the dielectric constant of the dielectric fluid 120. When the dielectric constant of the dielectric fluid 120 increases, the contraction efficiency of the HASEL actuator 10 is improved.

The dielectric fluid 120 includes nanoparticles 410. The nanoparticles 410 may include strontium titanate (SrTiO3) or barium titanate (BaTiO3), which are ferroelectrics. The ferroelectrics are materials having a high dielectric constant. When nanoparticles containing ferroelectric are included in dielectric fluid 120, the dielectric constant of the dielectric fluid 120 increases. Since the dielectric constant of the dielectric fluid 120 increases, the contraction efficiency of the HASEL actuator 10 is improved. The nanoparticles 410 may include other ferroelectrics in addition to barium titanate and strontium titanate.

Since the ferroelectric has hydrophilicity, the nanoparticles 410 may not be well dispersed in the dielectric fluid 120. Accordingly, the nanoparticles 410 may be coated with carbon 420. The nanoparticles 410 coated with carbon 420 may be well dispersed in the dielectric fluid 120. When carbon 420-coated nanoparticles 410 are well dispersed in dielectric fluid 120, the dielectric constant of the dielectric fluid 120 increases. Since the dielectric constant of the dielectric fluid 120 increases, the contraction efficiency of the HASEL actuator 10 is improved. That is, by including the carbon 420-coated nanoparticles 410 in the dielectric fluid 120, the contraction efficiency of the HASEL actuator 10 is improved regardless of the size or shape of the HASEL actuator 10.

Before the HASEL actuator 10 is actuated, voltage is not applied to the electrode 130, and thus, the electrode 130 does not shrink. Therefore, the dielectric fluid 120 including the carbon 420-coated nanoparticles 410 does not move upward. When the HASEL actuator 10 is actuated, voltage is applied to the electrode 130 and the electrode 130 contracts due to electrostatic force. The dielectric fluid 120 including nanoparticles 410 coated with carbon 420 between the electrodes 130 moves to a non-contracting portion. That is, the dielectric fluid 120 including nanoparticles 410 coated with carbon 420 moves upward. The shape of the film 110 is deformed by the hydraulic pressure generated as the dielectric fluid 120 including nanoparticles 410 coated with carbon 420 moves upward.

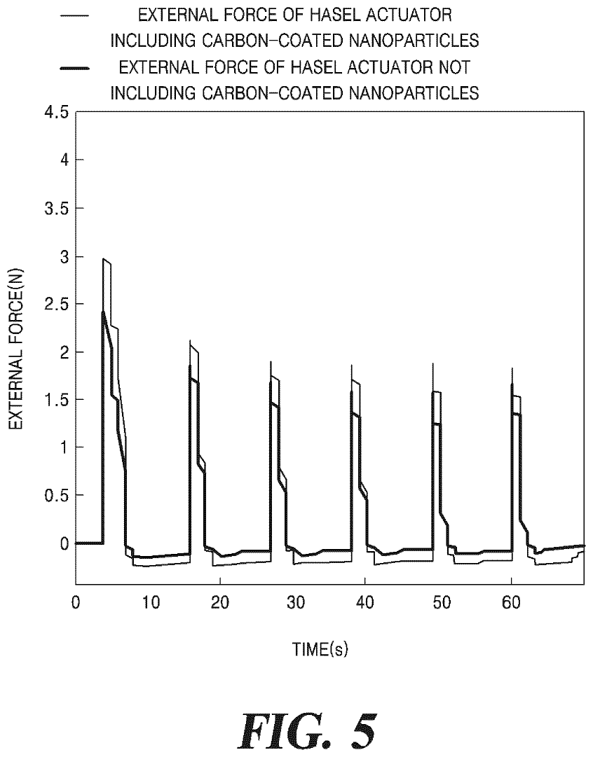

FIG. 5 is a view illustrating an average external force of the HASEL actuator by voltage application according to one embodiment of the present disclosure.

Referring to FIG. 5, when a voltage is applied to the HASEL actuator including carbon 420-coated nanoparticles 410 and the HASEL actuator not including carbon 420-coated nanoparticles 410, an external force is generated by the movement of dielectric fluid 120. The average external force of the HASEL actuator including the carbon 420-coated nanoparticles 410 generated by the voltage application and the average external force of the HASEL actuator not including the carbon 420-coated nanoparticles 410 generated by the voltage application are expressed over time.

When a voltage of 10 kV is applied to the HASEL actuator including the carbon 420-coated nanoparticles 410 and the HASEL actuator not including the carbon 420-coated nanoparticles 410, in the range of 0 to 10 seconds(s), the maximum average external force of the HASEL actuator including the carbon 420-coated nanoparticles 410 may be measured as 2.995 N, and the maximum average external force of the HASEL actuator not including the carbon 420-coated nanoparticles 410 may be measured as 2.445 N. In the interval after 10 seconds, the average external force of the HASEL actuator including the carbon 420-coated nanoparticles 410 may be measured to be greater than the average external force of the HASEL actuator not including the carbon 420-coated nanoparticles 410.

That is, the HASEL actuator including the carbon 420-coated nanoparticles 410 can have the maximum average external force that is about 20% higher than the HASEL actuator not including the carbon 420-coated nanoparticles 410. In another embodiment, in order to generate a maximum average external force equal to the maximum average external force of the HASEL actuator that does not include the carbon 420-coated nanoparticles 410, the magnitude of the voltage applied to the HASEL actuator that includes the carbon 420-coated nanoparticles 410 may be 20% smaller than the magnitude of the voltage applied to the HASEL actuator that does not include the carbon 420-coated nanoparticles 410.

When the external force of the HASEL actuator increases, the HASEL actuator should deform less, and when the external force of the HASEL actuator decreases, the HASEL actuator can deform more, so trade-off occurs between the deformation and the external force. The trade-off is a trade-off relationship that has a trade-off relationship between two elements. Accordingly, it is necessary to increase the strain of the HASEL actuator relative to the external force of the HASEL actuator, or to increase the external force of the HASEL actuator relative to the strain of the HASEL actuator.

Since the HASEL actuator including the carbon 420-coated nanoparticles 410 has a higher maximum average external force than the HASEL actuator not including the carbon 420-coated nanoparticles 410, the HASEL actuator including the carbon 420-coated nanoparticles 410 outputs the maximum average external force higher than the strain. Accordingly, the trade-off between the strain and the external force can be improved by including the carbon 420-coated nanoparticles 410 in the dielectric fluid 120 of the HASEL actuator.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A hydraulically amplified self-healing electrostatic (HASEL) actuator comprising:
a dielectric fluid, which is a liquid-type insulator that has polarity when voltage is applied;
a film configured to covering the dielectric fluid; and
electrodes attached to both outer surfaces of the film and configured to move the dielectric fluid, wherein the dielectric fluid includes nanoparticles including ferroelectrics.

2. The HASEL actuator of claim 1, wherein the film is a biaxially oriented polypropylene (BOPP) film.

3. The HASEL actuator of claim 1, wherein a (+) wire and a (−) wire are connected to the electrodes.

4. The HASEL actuator of claim 3, wherein a voltage is applied to the electrodes using the (+) wire and the (−) wire.

5. The HASEL actuator of claim 1, wherein when voltage is applied to the electrodes, the electrodes contract.

6. The HASEL actuator of claim 1, wherein when voltage is not applied to the electrodes, the electrodes does not contract.

7. The HASEL actuator of claim 5, wherein when the electrodes contract, the dielectric fluid between the electrodes moves to a space in which the electrodes does not contract.

8. The HASEL actuator of claim 5, wherein when the electrodes contract, a shape of the film is deformed.

9. The HASEL actuator of claim 1, wherein the ferroelectric is barium titanate (BaTiO₃).

10. The HASEL actuator of claim 1, wherein the ferroelectric is strontium titanate (SrTiO₃).

11. The HASEL actuator of claim 1, wherein the nanoparticles are carbon-coated.

12. The HASEL actuator of claim 11, wherein a dielectric constant of the dielectric fluid is increased by the nanoparticles.
